(19) United States
(12) Patent Application Publication
(10) Pub. No.: US 2026/0228983 A1
(43) Pub. Date: Aug. 6, 2026

(54) Virtual Reality Content Creation based on Video

(71) Applicant: DISH Network L.L.C., Englewood, CO (US)

(72) Inventor: Roger Ashworth, JR., Englewood, CO (US)

(21) Appl. No.: 19/045,324

(22) Filed: Feb. 4, 2025

(51) Int. Cl. G06T 19/00

(52) U.S. Cl. CPC G06T 19/003; G06T 2219/024

(57) ABSTRACT

Various arrangements for providing a virtual environment are presented herein. A virtual location creator computer system can receive an indication of a first scene from media content. A second scene can be determined from the media content that correspond to a same location as the first scene. Location characteristics can be obtained for a physical location based on the first scene and the second scene. Metadata mapped to the media content can be retrieved. A three-dimensional virtual environment can be constructed based on the set of location characteristics and the retrieved metadata. The three-dimensional virtual environment can then be provided to a virtual environment navigation system to allow an end user to navigate within the three-dimensional virtual environment.

### BACKGROUND

Movies, television shows, sporting events, documentaries, and other forms of media content can provide endless hours of entertainment for consumers. However, many modern consumers prefer more interaction with their media, such as in the form of video games that allow for navigation through richly detailed three dimensional worlds. Conventional media, such as movies and television series, do not always provide such opportunities. Detailed herein are arrangements that allow for a bridging of this gap between the experience provided by traditional media content and the experience provided via three-dimensional virtual reality equipment and gaming.

### SUMMARY

In some embodiments, a method for providing a virtual environment is presented. A virtual location creator computer system may receive an indication of a first scene from media content. It may determine a second scene from the media content that corresponds to the same location as the first scene. The system may obtain a set of location characteristics for a physical location based on the first scene and the second scene. It may also retrieve metadata mapped to the media content. Using the set of location characteristics and the retrieved metadata, the system may construct a three-dimensional virtual environment. Finally, the system may provide the three-dimensional virtual environment to a virtual environment navigation system, allowing an end user to navigate within the three-dimensional virtual environment.

Embodiments of such a method can include one or more of the following features. Each of these features can be separately incorporated into the method detailed above. The indication may be based on a user selection by the end user of the first scene. Constructing the three-dimensional virtual environment may be performed using an artificial intelligence model. The virtual location creator computer system may determine an amount of time the end user is engaged with the three-dimensional virtual environment, and it may provide access to the three-dimensional virtual environment to a plurality of end users based at least in part on the amount of time. The virtual location creator computer system may receive user feedback from the end user about the three-dimensional virtual environment, and it may provide access to the three-dimensional virtual environment to a plurality of end users based at least in part on the user feedback. Providing access to the three-dimensional virtual environment to the plurality of end users may comprise adding the three-dimensional virtual environment to a virtual environment library made available to the plurality of end users. A user interface of a plurality of three-dimensional virtual environments, including the three-dimensional virtual environment, may be provided for access by the plurality of end users. The virtual location creator computer system may analyze whether the first scene has been tagged as blocked from being created as the three-dimensional virtual environment, and in response to determining that the first scene has not been tagged as blocked, it may permit the creation of the three-dimensional virtual environment. The virtual location creator computer system may retrieve location data for the physical location from a content provider, and constructing the three-dimensional virtual environment may be further based on the location data obtained from the content provider.

In some embodiments, a system is presented. A system for providing a virtual environment may include a content provider system that is configured to stream video to an end user device. The system may also include a virtual location creator system, in communication with the content provider system, comprising one or more processors. The virtual location creator system may be configured to receive an indication of a first scene from media content. It may determine a second scene from the media content that corresponds to the same location as the first scene. The system may obtain a set of location characteristics for a physical location based on the first scene and the second scene. Additionally, it may retrieve metadata mapped to the media content. Using the set of location characteristics and the retrieved metadata, the system may construct a three-dimensional virtual environment. Finally, the system may provide the three-dimensional virtual environment to a virtual environment navigation system, allowing an end user to navigate within the three-dimensional virtual environment.

Embodiments of such a system can include one or more of the following features. Each of these features can be separately incorporated into the system detailed above. The virtual location creator system may be incorporated as part of the content provider system. The system may further comprise a virtual environment navigation system. It may also include a television receiver, wherein the indication is based on a user selection by the end user of the first scene made via the television receiver. Constructing the three-dimensional virtual environment may be performed using an artificial intelligence model. The virtual location creator system may be further configured to determine an amount of time the end user is engaged with the three-dimensional virtual environment and may provide access to the three-dimensional virtual environment to a plurality of end users based at least in part on the amount of time. The virtual location creator system may also be configured to receive user feedback from the end user about the three-dimensional virtual environment and provide access to the three-dimensional virtual environment to a plurality of end users based at least in part on the user feedback. Furthermore, the virtual location creator system may provide a user interface of a plurality of three-dimensional virtual environments, including the three-dimensional virtual environment, for access by the plurality of end users. The virtual location creator system may analyze whether the first scene has been tagged as blocked from being created as the three-dimensional virtual environment and, in response to determining that the first scene has not been tagged as blocked, may permit the creation of the three-dimensional virtual environment. Additionally or alternatively, the virtual location creator system may retrieve location data for the physical location from a content provider, and constructing the three-dimensional virtual environment may be further based on the location data obtained from the content provider.

A non-transitory processor-readable medium may comprise processor-readable instructions configured to cause one or more processors to perform various operations. The processors may be configured to receive an indication of a first scene from media content. They may determine a second scene from the media content that corresponds to the same location as the first scene. The processors may obtain a set of location characteristics for a physical location based on the first scene and the second scene. Additionally, they may retrieve metadata mapped to the media content. Using the set of location characteristics and the retrieved metadata, the processors may construct a three-dimensional virtual environment. Finally, the processors may provide the three-dimensional virtual environment to a virtual environment navigation system to allow an end user to navigate within the three-dimensional virtual environment.

### BRIEF DESCRIPTION OF THE DRAWINGS

A further understanding of the nature and advantages of various embodiments may be realized by reference to the following figures.

FIG. 1 illustrates an embodiment of a system for providing a virtual environment based on media content.

FIG. 2 illustrates an embodiment of an arrangement for identifying relevant scenes from media content.

FIG. 3 illustrates an embodiment of a method for providing a virtual environment based on media content.

FIG. 4 illustrates an embodiment for determining to provide access to users to a three-dimensional environment based on feedback.

### DETAILED DESCRIPTION

Particular scenes in movies, television shows, and other video content may tend to capture the interest of viewers. The interest is not always exclusively tied to the plot and characters, but rather the physical location of the scene and, possibly, the set designed for the scene. Famous scenes in media in recent years include scenes set on spaceships and foreign worlds from multiple science fiction movies and series, scenes based on the interior and exterior of a ranch in Montana, a New York apartment shared by friends, and a make-believe world based around a doll and its accessories. While consumers may enjoy seeing the movies, series, documentaries, and sporting events set at both real and fictional locations, the consumers long for more.

In embodiments detailed herein, an end user has the ability to identify a desired scene, and have a three-dimensional environment constructed that allows for exploration of the physical location, whether real or fictional, of the scene. Depending on embodiments, characters that are present in the scene may also be included in the three-dimensional environment or may not be included. When requested, the particular scene may be analyzed to determine one or more additional scenes from the same media content (e.g., movie) that corresponds to the same physical location. Metadata for the media content can be used to obtain details about the physical location of the scene, such as the year in which the scene was set. Additional information on the scene can be obtained from other episodes of the same series and from materials provided by the content creator.

Typically, conventional media only provides particular angles of any physical scene, so at least some visual aspects of the environment need to be created without a visual reference in the media content. An artificial intelligence arrangement can be trained to create a seamless virtual environment that remains accurate to the media content but fill in the gaps based on the style, time period, and similar content available from other sources.

Once created, a user can navigate through the environment and provide feedback on the experience. In some embodiments, the user can do more than navigate. Interaction with the environment may be possible, such as by picking up objects, moving objects, opening and closing doors, controlling machines, etc. Environments that are well-reviewed can be provided to other users, such as via a library of available three-dimensional environments, thus allowing multiple users to enjoy the same environments. Conversely, poorly-reviewed environments can be not made available or reconstructed using artificial intelligence to create a separate iteration that may be more enjoyable to end users. The user may also be permitted to share a particular environment, such as by distributing a link or posting a link to social media.

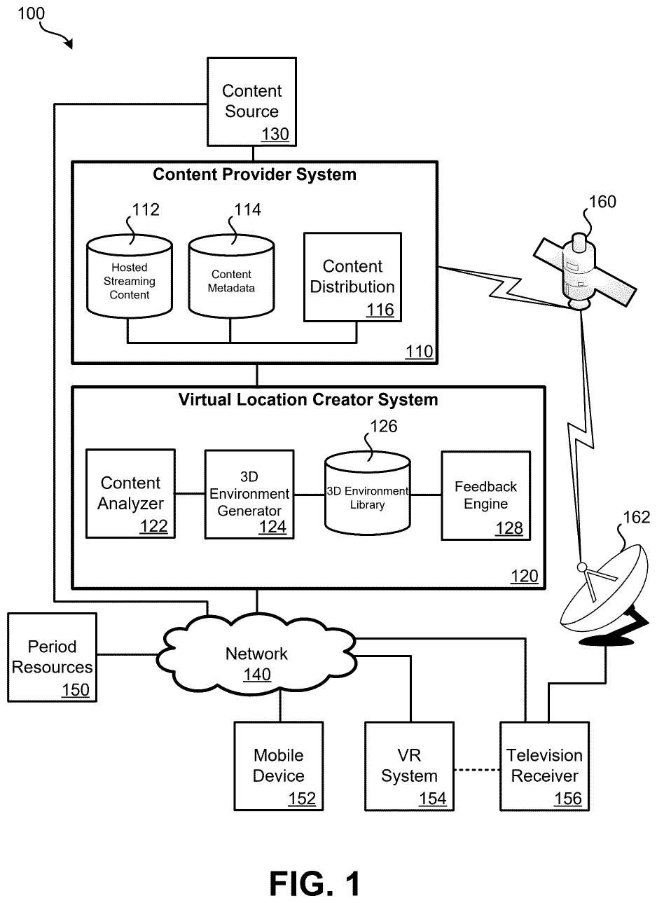

FIG. 1 illustrates an embodiment of a system 100 for providing a virtual environment based on media content. System 100 can include: content provider system 110; virtual location creator system 120; content source 130; network 140; period resources 150; mobile device 152; virtual reality (VR) system 154; television receiver 156; satellite 160; and satellite antenna 162. Content provider system 110 represents any form of computerized provider system that allows various end users to stream or otherwise receive media content. Content provider system 110 may be a television service provider that broadcasts multiple live television channels and may also provide access to streaming content that is available on demand. Alternatively, content provider system 110 may only provide access to streaming content on demand. Content provider system 110 may function as an over-the-top service or may make use of a dedicated content distribution network, such as a cable network or satellite-based television distribution network. As illustrated in FIG. 1, content provider system 110 uses satellite 160 to broadcast content to various end users, such as to television receiver 156 (e.g., set top box, set back box, television receiver integrated as part of a television) via satellite antenna 162. Additionally or alternatively, content can be delivered via network 140, both to television receiver 156 and mobile device 152 (e.g., a smartphone, tablet computer, gaming device, etc.). Collectively, device which can output content for presentation can be referred to as end user devices.

Content provider system 110 can receive transmissions of one or more live television channels, such as a live television channel from content source 130. Such a live television channel may be rebroadcast via satellite 160 or otherwise redistributed via network 140 to end users of content provider system 110. Hosted streaming content 112 can represent a database of content available for streaming by end users. Via components mobile device 152 or television receiver 156, end users can request streaming media from content provider system 110.

Content provider system 110 can include content metadata datastore 114. Content metadata datastore 114 can store information about media content that is streamed, broadcast, or otherwise provided to end-users, such as: a summary of the plot, the rating, a list of actors appearing in the media content, a detail of the setting of the media content, etc. content distribution 116 may represent a system that is used to convert streaming content and/or live content for transmission via satellite 160 to television receiver 156 via satellite antenna 162.

As illustrated virtual location creator system 120 is shown as distinct from content provider system 110. These two systems can be operated independently in cooperation with each other, or, alternatively, virtual location creator system 120 can be incorporated as part of content provider system 110.

Virtual location creator system 120 can include one or more computer systems that are used to perform the functions detailed in relation to the following components: content analyzer 122 and three-dimensional environment generator 124. In response to a trigger, content analyzer 122 may serve to analyze a particular scene of a piece of media content (which comprises video, but not necessarily audio content) obtained from content provider system 110. The trigger may be based on user input. For example, while an end user is viewing media content received from content provider system 110 via mobile device 152 or television receiver 156, the end user may have the option of providing a command or other form of input that selects a particular scene in which the end-user is interested in exploring in three dimensions. This command may get transmitted to content analyzer 122 along with an indication of the scene that was being presented when the end-user issued the command. In response, content analyzer 122 may analyze the scene to obtain as much information as possible about the physical location, regardless of whether it is a fictional location, nonfictional location, rendered, cartoon, etc.

Content analyzer 122 may also analyze the remainder of the media content (i.e., portions of the media content from before and after the scene) to determine if additional portions of the media content correspond to the same physical location. If so, information from these scenes may also be gathered by content analyzer 122. As a possible addition, if the piece of media is part of a series, such as a television series or streaming series, additional information may be gathered from scenes in other episodes that correspond to the same physical location. As a real-world example, an end user may be interested in exploring the Dutton Yellowstone Ranch from the televised series “Yellowstone.” Many different angles of the exterior of the ranch and buildings located on the ranch are captured throughout the series. Data from all of this video content can be aggregated by content analyzer 122.

Content analyzer 122 may also analyze content metadata obtained from content metadata datastore 114 that corresponds to the media content. Such information may be particularly useful in reconstructing portions of the physical environment that are not readily visible in the video content available to content analyzer 122. For example, content metadata may indicate that the scene corresponding to the physical location to be created in three dimensions is set in the 1890's. This information can be used to ensure that materials and devices created after this time period is not included as part of the three-dimensional environment and the period-appropriate materials and objects are included.

Content analyzer 122 can also access materials that are not directly related to the piece media content. For example, for use in filling in gaps, period resources 150 can be accessed via network 140. Period resources 150 can represent any content available via the Internet that may be useful in constructing the three-dimensional environment. For example, in constructing a three-dimensional environment corresponding to the 1890's, materials on trains, buildings, farming equipment, etc. from that time period may be accessed. Additionally or alternatively, a content source, such as content source 130 may provide additional detailed materials that may be useful in creating a three-dimensional environment. For example, for a television series films on a spaceship, the content source that created the television series may provide access to drawings, renderings, models, or other materials that may be useful in creating a three-dimensional environment.

Three-dimensional environment generator 124 may use the information gathered by content analyzer 122 to construct a three-dimensional environment. Three-dimensional environment generator 124 may utilize artificial intelligence in order to generate the environment and filling gaps where video from the media content is insufficient to determine specifics about the three-dimensional environment being created. It is for such gaps that three-dimensional environment generator 124 may rely on the ancillary information gathered by content analyzer 122, such as from the content metadata, period resources, and other materials made available by the content source.

Once created, the data corresponding to the three-dimensional environment created by three-dimensional environment generator 124 may be output via network 140 to VR system 154. VR system 154 may have been previously mapped by the end user to the same account as television receiver 156 and/or mobile device 152. Therefore, by the user providing a trigger on the scene to be used to generate the three-dimensional environment, the three-dimensional environment, once created is delivered to the proper virtual reality system. In some embodiments, VR system 154 is a headset that is worn by the end-user, with the three-dimensional environment being viewed through one or more displays integrated in the goggles. Other forms of VR system 154 are also possible.

In some embodiments, the data for the three-dimensional environment created by the three-dimensional environment generator 124 can be transmitted to television receiver 156 via content provider system 110 and satellite 160. Data for the three-dimensional environment will be transmitted to VR system 154 directly by television receiver 156.

Via either VR system 154, television receiver 156, or mobile device 152, the end user can provide feedback to feedback engine 128 of virtual location creator system 120. This feedback can be used to assess whether the generated three-dimensional environment is to be saved to three-dimensional environment library 126. Feedback engine 128 may use various pieces of data to determine whether the generated three-dimensional environment should be stored. One factor that may be measured is the amount of time with which the end-user interacts with the three-dimensional environment via VR system 154. Feedback, such as in the form of the score, may be provided by the user after experiencing the three-dimensional environment. If feedback is positive enough, the three-dimensional environment may be stored in three-dimensional environment library 126 to be made available to other end-users. Other end-users may be able to select from a listing of previously generated three-dimensional environments that they may desire to explore or the three-dimensional environment may be stored in case another end-user every requests that a three-dimensional environment be generated based on the same or a similar scene of the same or related media content.

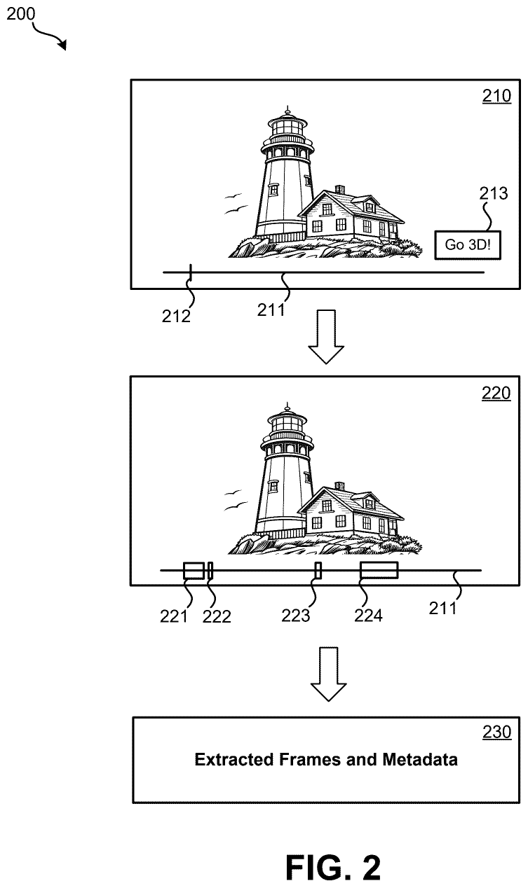

FIG. 2 illustrates an embodiment 200 of an arrangement for identifying relevant scenes from media content. Scene 210 may be presented, as part of the menu that presents a scrub bar 211 with a current location in playback 212, a user may be provided with an opportunity to explore a three-dimensional environment by selecting element 213.

When element 213 is selected, the remainder of the scene may be analyzed to gather information about the currently presented outdoor location of the scene, as indicated by region 221 on scrub bar 211. Additionally, other scenes that are determined to occur at the same physical location may be identified, as indicated by regions 222, 223, and 224 on scrub bar 211. Alternative views and angles of the outdoor location may be used from these other scenes to gather additional information on the outdoor location for use in creating a three-dimensional environment.

The extracted frames from the scenes, possibly along with metadata 230, that corresponds to the media content, may be provided to three-dimensional environment generator 124 for use in creating the three-dimensional environment. As previously noted, additional information, such as from period resources 150 and/or directly from the content source that created the media content may additionally be used. Further, a trained artificial intelligence model may be used to fill in gaps to create a complete three-dimensional environment through which the end user can navigate.

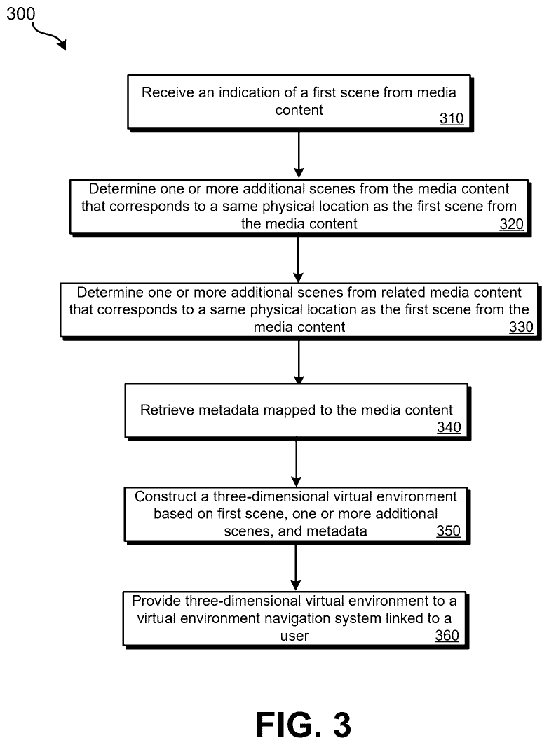

Various methods can be performed using the systems detailed in relation to FIGS. 1 and 2. FIG. 3 illustrates an embodiment of a method 300 for providing a virtual environment based on media content. Each block of method 300 may be performed using a virtual location creator system, such as detailed in relation to FIG. 1.

At block 310, the process begins by receiving an indication of a first scene from a piece of media content. This media content is video based, such as a movie, television show, documentary, clip, sporting event, cartoon, etc. Characteristics (e.g., objects, colors, materials, textures, walls, etc.) from this first scene can serve as the initial reference point for further analysis and the construction of a virtual physical environment based upon the physical environment present in the first scene of the media content. The indication can be based on a user selecting a particular scene or otherwise providing an indication of it. Such a selection or indication can be provided via the user's mobile device or television receiver.

In some embodiments, a preliminary step may be performed in which a determination is made as to whether generation of a three-dimensional environment based on scene is permissible. Certain scenes, which represent mature material or are otherwise sensitive in nature, may be prohibited from being generated into a three-dimensional environment. Such a prohibition may be stored in the metadata associated with the media content. If prohibited, method 300 may be prohibited from progressing based on the restriction. The user may be provided with an alternative option.

At block 320, one or more additional scenes from the same media content may be determined. These additional scenes are scenes set in the same physical location as the first scene and may provide different perspectives or angles of the location. This block enables the aggregation of visual data from the media content to enhance the representation of the physical environment.

At block 330, one or more additional scenes from related media content are determined. These related media content scenes correspond to the same physical location as the first scene but are sourced from different discrete pieces of media content (e.g., other episodes in the same series, other movies in the same franchise). Integrating scenes from related media content allows for a more comprehensive depiction of the physical environment indicated at block 310 by leveraging complementary visual data, such as additional angles of the physical environment.

At block 340, metadata associated with the media content is retrieved. This metadata may include details such as dates, time periods, geolocation data, camera angles, or descriptive attributes that can be used to reconstruct the physical location of scene.

In some embodiments, additional resources can be used to obtain information that can be used to fill regions of missing visual data for the three dimensional environment. A television show may tend to show a particular physical location from only one or two angles, therefore information will need to be created to approximate what the physical location would likely look like from other angles. As detailed in relation to FIG. 1, information directly from the content source that created the content or from period resources may be used to make the prediction.

At block 350, a three-dimensional virtual environment is constructed based on characteristics from the first scene, the one or more additional scenes, the retrieved metadata, and, possibly other data sources used to predict the physical location. Artificial intelligence and other advanced computational methods may be employed to fill gaps where visual data is incomplete. Block 350 can utilize techniques such as three-dimensional modeling, spatial mapping, and scene reconstruction to accurately replicate the physical location depicted in the media content as received at block 310.

At block 360, the constructed three-dimensional virtual environment is provided to a virtual environment navigation system linked to an end user, such as VR system 154. The VR system allows the end user to interact with and explore the virtual environment in an immersive manner. The end user can navigate through the environment and, possibly, also interact with objects present in the environment, such as by moving them. In some embodiments, characters may also be present in the environment, with which the end user can interact, such as via speech or through physical interaction (e.g., handshake, cooperatively move objects or pilot a ship, etc.). The virtual environment may be experienced through virtual reality (VR) headsets, augmented reality (AR) displays, or standard computing interfaces, depending on the user's device and application context.

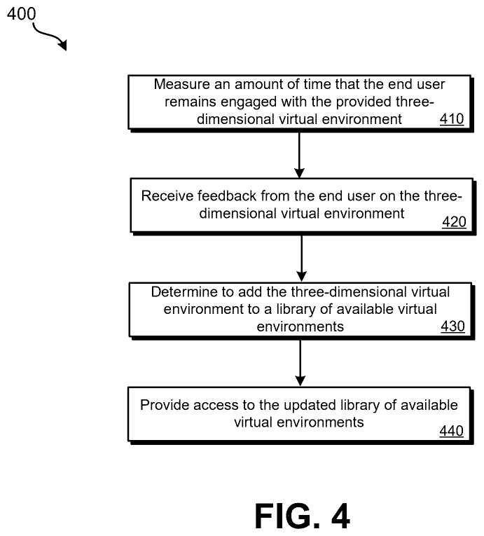

To further improve the three dimensional environments provided, feedback can be solicited and used to curate the three dimensional environments made available to end users. FIG. 4 illustrates an embodiment of a method 400 for determining to provide access to users to a three-dimensional environment based on feedback. Method 400 can be performed after method 300 has been performed.

At block 410, an amount of engagement time of the end user with the three-dimensional virtual environment is measured. In this block, the VR system or virtual location creator system measures an amount of time the end user remains engaged with the provided three-dimensional virtual environment, such as an amount of time the end user is actively navigating through the environment. Generally, the more time spent interacting with an environment, the more it can be assumed the user found it interesting. A defined threshold may be set that serves to indicate whether the user had at least some level of baseline interest in it (e.g., 3 minutes).

At block 420, user feedback can be received. The virtual location creator system can receive feedback from the end user regarding their experience with the three-dimensional virtual environment. This feedback may include qualitative or quantitative input, such as user ratings, comments, or specific preferences, which help determine the quality and usability of the virtual environment. For example, the user may be permitted to provide feedback that is considered when a regeneration of the three-dimensional environment is performed. If the user did not rate the environment well, the environment may not be preserved and may be regenerated from scratch at some future time if requested by another end user.

At block 430, based on the engagement metrics and user feedback, the virtual location creator system evaluates whether to add the three-dimensional virtual environment to a library of available virtual environments. A scoring algorithm can be used to combine the engagement metrics and user feedback to determine whether to add the three-dimensional virtual environment to the library of available virtual environments. For example, each minute of engagement may be awarded some number of points, a positive review by the user may be provided some number of points, and if the total number of points exceeds a threshold, the three-dimensional virtual environment is added to the library of available virtual environments. This decision-making process ensures that only relevant and well-received virtual environments are included in the library.

At block 440, the library of available virtual environments is updated and access is provided to end users to be able to search, navigate, and select available virtual environments for use. The most popular and highest ranked available virtual environments may be provided strong prominence. Further, an indication of the most popular available virtual environment may be presented along with the media content as output by content provider system 110. Therefore, when another user is watching the media content, an option may be presented for the user to view the corresponding virtual environment. Such an option may be presented as part of an electronic programming display of television receiver 156 or when the specific scene corresponding to the virtual environment is being output by television receiver 156 (or mobile device 152).

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known, processes, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the scope of the claims.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Having described several embodiments, it will be recognized by those of skill in the art that various modifications, alternative constructions, and equivalents may be used without departing from the scope of the claims. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A method for providing a virtual environment, the method comprising:
receiving, by a virtual location creator computer system, an indication of a first scene from media content;
determining, by the virtual location creator computer system, a second scene from the media content that correspond to a same location as the first scene;
obtaining, by the virtual location creator computer system, a set of location characteristics for a physical location based on the first scene and the second scene;
retrieving, by the virtual location creator computer system, metadata mapped to the media content;
constructing, by the virtual location creator computer system, a three-dimensional virtual environment based on the set of location characteristics and the retrieved metadata; and
providing, by the virtual location creator computer system, the three-dimensional virtual environment to a virtual environment navigation system to allow an end user to navigate within the three-dimensional virtual environment.

2. The method for providing the virtual environment of claim 1, wherein the indication is based on a user selection by the end user of the first scene.

3. The method for providing the virtual environment of claim 1, wherein constructing the three-dimensional virtual environment is performed using an artificial intelligence model.

4. The method for providing the virtual environment of claim 1, further comprising:
determining, by the virtual location creator computer system, an amount of time the end user is engaged with the three-dimensional virtual environment; and
providing, by the virtual location creator computer system, access to the three-dimensional virtual environment to a plurality of end users based at least in part on the amount of time.

5. The method for providing the virtual environment of claim 1, further comprising:
receiving, by the virtual location creator computer system, user feedback from the end user about the three-dimensional virtual environment; and
providing, by the virtual location creator computer system, access to the three-dimensional virtual environment to a plurality of end users based at least in part on the user feedback.

6. The method for providing the virtual environment of claim 5, wherein providing access to the three-dimensional virtual environment to the plurality of end users comprises adding the three-dimensional virtual environment to a virtual environment library made available to the plurality of end users.

7. The method for providing the virtual environment of claim 6, further comprising:
providing a user interface of a plurality of three-dimensional virtual environments, comprising the three-dimensional virtual environment, for access by the plurality of end users.

8. The method for providing the virtual environment of claim 1, further comprising:
analyzing, by the virtual location creator computer system, whether the first scene has been tagged as blocked from being created as the three-dimensional virtual environment; and
in response to determining that the first scene has not been tagged as blocked, permitting creation of the three-dimensional virtual environment.

9. The method for providing the virtual environment of claim 1, further comprising:
retrieving, by the virtual location creator computer system from a content provider, location data for the physical location, wherein constructing the three-dimensional virtual environment is further based on the location data obtained from the content provider.

10. A system for providing a virtual environment, the system comprising:
a content provider system configured to stream video to an end user device;
a virtual location creator system, in communication with the content provider system, comprising one or more processors, wherein the virtual location creator system is configured to:
receive an indication of a first scene from media content;
determine a second scene from the media content that correspond to a same location as the first scene;
obtain a set of location characteristics for a physical location based on the first scene and the second scene;
retrieve metadata mapped to the media content;
construct a three-dimensional virtual environment based on the set of location characteristics and the retrieved metadata; and
provide the three-dimensional virtual environment to a virtual environment navigation system to allow an end user to navigate within the three-dimensional virtual environment.

11. The system of claim 10, wherein the virtual location creator system is incorporated as part of the content provider system.

12. The system of claim 11, further comprising the virtual environment navigation system.

13. The system of claim 10, further comprising a television receiver, wherein the indication is based on a user selection by the end user of the first scene made via the television receiver.

14. The system of claim 10, wherein constructing the three-dimensional virtual environment is performed using an artificial intelligence model.

15. The system of claim 10, wherein the virtual location creator system is further configured to:
determine an amount of time the end user is engaged with the three-dimensional virtual environment; and
provide access to the three-dimensional virtual environment to a plurality of end users based at least in part on the amount of time.

16. The system of claim 10, wherein the virtual location creator system is further configured to:
receive user feedback from the end user about the three-dimensional virtual environment; and
provide access to the three-dimensional virtual environment to a plurality of end users based at least in part on the user feedback.

17. The system of claim 16, wherein the virtual location creator system is further configured to:
provide a user interface of a plurality of three-dimensional virtual environments, comprising the three-dimensional virtual environment, for access by the plurality of end users.

18. The system of claim 10, wherein the virtual location creator system is further configured to:
analyze whether the first scene has been tagged as blocked from being created as the three-dimensional virtual environment; and
in response to determining that the first scene has not been tagged as blocked, permit creation of the three-dimensional virtual environment.

19. The system of claim 10, wherein the virtual location creator system is further configured to:
retrieve, from a content provider, location data for the physical location, wherein constructing the three-dimensional virtual environment is further based on the location data obtained from the content provider.

20. A non-transitory processor-readable medium comprising processor-readable instructions configured to cause one or more processors to:
receive an indication of a first scene from media content;
determine a second scene from the media content that correspond to a same location as the first scene;
obtain a set of location characteristics for a physical location based on the first scene and the second scene;
retrieve metadata mapped to the media content;
construct a three-dimensional virtual environment based on the set of location characteristics and the retrieved metadata; and
provide the three-dimensional virtual environment to a virtual environment navigation system to allow an end user to navigate within the three-dimensional virtual environment.
